(19) United States
(12) Patent Application Publication
(10) Pub. No.: US 2026/0030805 A1
(43) Pub. Date: Jan. 29, 2026

(54) IMAGE PROCESSING USING KERNELS

(71) Applicant: QUALCOMM Incorporated, San Diego, CA (US)

(72) Inventors: Navodit CHANDRA, Hyderabad (IN); Gururaj BHAT, Hyderabad (IN); Ashish MEDEWAR, Hyderabad (IN)

(21) Appl. No.: 18/783,248

(22) Filed: Jul. 24, 2024

(51) Int. Cl. G06T 11/60; G06T 7/13; G06T 7/194; G06T 7/50

(52) U.S. Cl. CPC G06T 11/60; G06T 7/13; G06T 7/194; G06T 7/50; G06T 2207/30168

(57) ABSTRACT

Systems and techniques are described herein for modifying image data. For instance, a method for modifying an image is provided. The method may include determining a first kernel for a pixel of an image based on pixel values of a window of pixels of the image; determining a second kernel for the pixel of the image based on depth data of a window of depth information, wherein the depth information is related to the image; combining the first kernel with the second kernel to generate a combined kernel; and modifying the pixel based on the combined kernel.

### TECHNICAL FIELD

The present disclosure generally relates to modifying images. For example, aspects of the present disclosure include systems and techniques for modifying images using kernels.

### BACKGROUND

Many devices can capture a representation of a scene by generating image data (e.g., images or image frames) and/or video data (including multiple frames) of the scene. For example, a camera or a device including a camera can capture a sequence of frames of a scene (e.g., a video of a scene). In some cases, image data and/or video data can be modified. Some image and/or video modification techniques modify image data based on distances between a device which captured the image data (e.g., a camera) and points in a scene represented by the image data. Such distances may be referred to as “depths” or “depth information.”

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for modifying image data. According to at least one example, a method is provided for modifying image data. The method includes: determining a first kernel for a pixel of an image based on pixel values of a window of pixels of the image; determining a second kernel for the pixel of the image based on depth data of a window of depth information, wherein the depth information is related to the image; combining the first kernel with the second kernel to generate a combined kernel; and modifying the pixel based on the combined kernel.

In another example, an apparatus for modifying image data is provided that includes at least one memory and at least one processor (e.g., configured in circuitry) coupled to the at least one memory. The at least one processor configured to: determine a first kernel for a pixel of an image based on pixel values of a window of pixels of the image; determine a second kernel for the pixel of the image based on depth data of a window of depth information, wherein the depth information is related to the image; combine the first kernel with the second kernel to generate a combined kernel; and modify the pixel based on the combined kernel.

In another example, a non-transitory computer-readable medium is provided that has stored thereon instructions that, when executed by one or more processors, cause the one or more processors to: determine a first kernel for a pixel of an image based on pixel values of a window of pixels of the image; determine a second kernel for the pixel of the image based on depth data of a window of depth information, wherein the depth information is related to the image; combine the first kernel with the second kernel to generate a combined kernel; and modify the pixel based on the combined kernel.

In another example, an apparatus for modifying image data is provided. The apparatus includes: means for determining a first kernel for a pixel of an image based on pixel values of a window of pixels of the image; means for determining a second kernel for the pixel of the image based on depth data of a window of depth information, wherein the depth information is related to the image; means for combining the first kernel with the second kernel to generate a combined kernel; and means for modifying the pixel based on the combined kernel.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 includes two example images to illustrate examples of various aspects of the present disclosure;

FIG. 2A is a block diagram illustrating an example system for modifying image data, according to various aspects of the present disclosure;

FIG. 2B is a block diagram illustrating the example system of FIG. 2A including representations of image data, depth data, and various kernels to illustrate examples of various aspects of the present disclosure;

FIG. 2C includes representations of a pixel window, a depth window, and various kernels to illustrate examples of various aspects of the present disclosure;

FIG. 3 includes an example image and a corresponding blur map, according to various aspects of the present disclosure;

FIG. 4 includes an example image and an example blur map, according to various aspects of the present disclosure;

FIG. 5 includes an example image and an example blur map, according to various aspects of the present disclosure;

FIG. 6 is a flow diagram illustrating an example process for modifying an image, in accordance with aspects of the present disclosure;

FIG. 7 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted above, some image and/or video modification techniques modify image data based on distances (or depths) between a device which captured the image data (e.g., a camera) and points in a scene represented by the image data. As an example, an artificial-bokeh technique may obtain depth information and identify foreground image pixels and background image pixels based on the depth information. The artificial-bokeh technique may blur the background image pixels which may cause the foreground image pixels to stand out. In some aspects, the artificial-bokeh technique may blur pixels based on the depths of the points in the scene represented by the pixels. For example, the artificial-bokeh technique may apply more blurring to pixels representing points deeper in a scene and applying less blurring to pixels representing points closer to the camera. Artificial-bokeh may be applied to image frames of video data and/or individual images.

Images modified according to artificial-bokeh may exhibit halo effects caused by color mixing at depth discontinuities. For example, an artificial-bokeh technique, when blurring pixels, may blend foreground image pixels with background image pixels at an edge of an object.

Systems, apparatuses, methods (also referred to as processes), and computer-readable media (collectively referred to herein as “systems and techniques”) are described herein for modifying images using kernels. For example, the systems and techniques described herein may obtain an image representing a scene and a disparity map (or depth map) representing the scene. A depth map may represent distances between a device which capture an image of the scene (and/or the depth map of the scene) and points in the scene (e.g., depths). For example, a depth may include depth values arranged in a gird, with each depth value corresponding to a distance between the device and a point in the scene. A disparity map may be indicative of distances between a device and points in the scene. A disparity map may include distances between matching pixels of stereoscopically-paired images. A disparity value of a disparity map can be used to calculate a depth value based on a known distance between devices that captured the stereoscopically-paired images.

The systems and techniques may determine a blur map based on the image and the disparity map (or depth map). The blur map may include a blur radius for each pixel of the image. A larger blur radius in the blur map for a particular pixel indicates that more pixels are to be included in a window used to determine a new value for the pixel (e.g., to blur the pixel). In another example, a smaller blur radius in the blur map for a pixel indicates that fewer pixels are to be included in a window used to determine a new value for the pixel. Foreground image pixels may have blur radius values of zero, which may indicate that the foreground image pixels are not to be blurred. Shallow background image pixels (that relate to points farther from a camera which captured the image than the foreground image pixels) may have a blur radius, which may indicate the shallow background image pixels are to be blended with pixel values of a window of surrounding background image pixels. Deeper background image pixels (that relate to points farther from a camera which captured the image than the shallow background pixels) may have a larger blur radius, which may indicate the deep background image pixels are to be blended with pixel values of a relatively large window of surrounding background image pixels.

The systems and techniques may determine a respective first kernel and a respective second kernel for each pixel of the image. Each first kernel and second kernel may be sized based on the blur radius of their respective pixels. The systems and techniques may determine a respective image-based kernel and a respective disparity-based kernel for each pixel of the image. The systems and techniques may combine each of the first kernels with a corresponding one of the second kernels to generate a combined kernel for each pixel of the image. The systems and techniques may apply the combined kernels to the pixels to which the combined kernels correspond.

Various aspects of the application will be described with respect to the figures below.

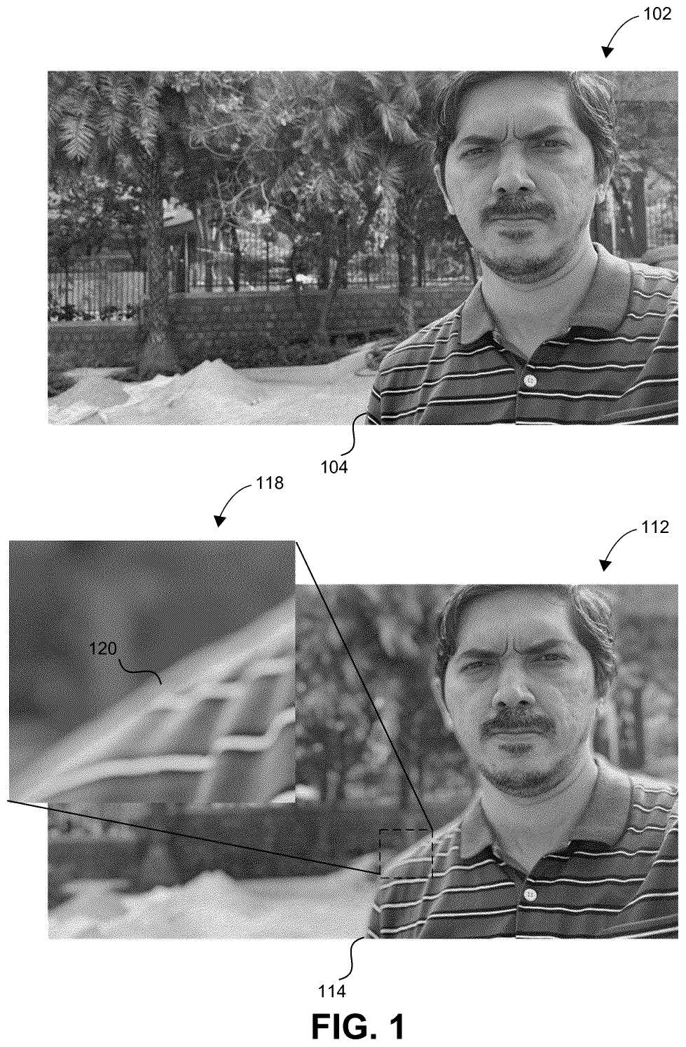

FIG. 1 includes two example images, image 102 and image 112, to illustrate examples of various aspects of the present disclosure. Image 102 is an example of image data captured by a camera. Image 112 is an example of image 102 after application of an artificial-bokeh technique. For example, a background of the scene represented by image 102 an image 112 is more clear in image 102 than it is in image 112. The artificial-bokeh technique blurred the background in image 112.

Image 112 exhibits a halo effect. For example, an edge of the foreground object (e.g., the person), is blurred. For example, edge 104 in image 102 is sharp. In contrast, edge 114 in image 112 exhibits a halo 120, as can be seen in inset 118. Halo 120 may be the result of blurring pixels of edge 114 with pixels from the foreground object and the background.

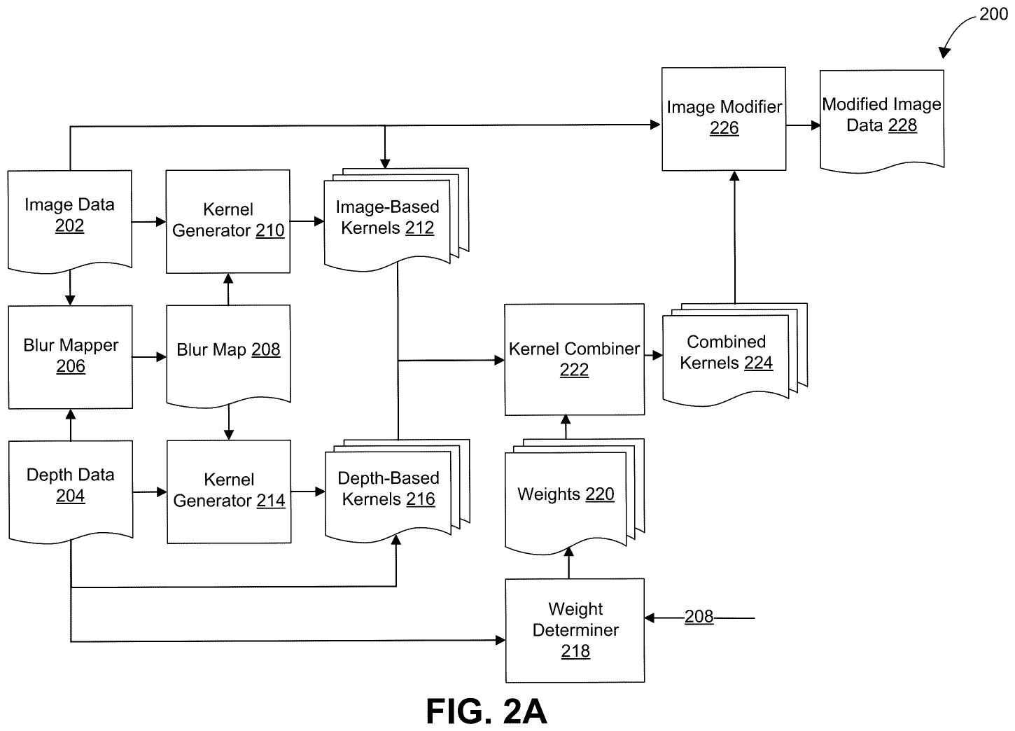

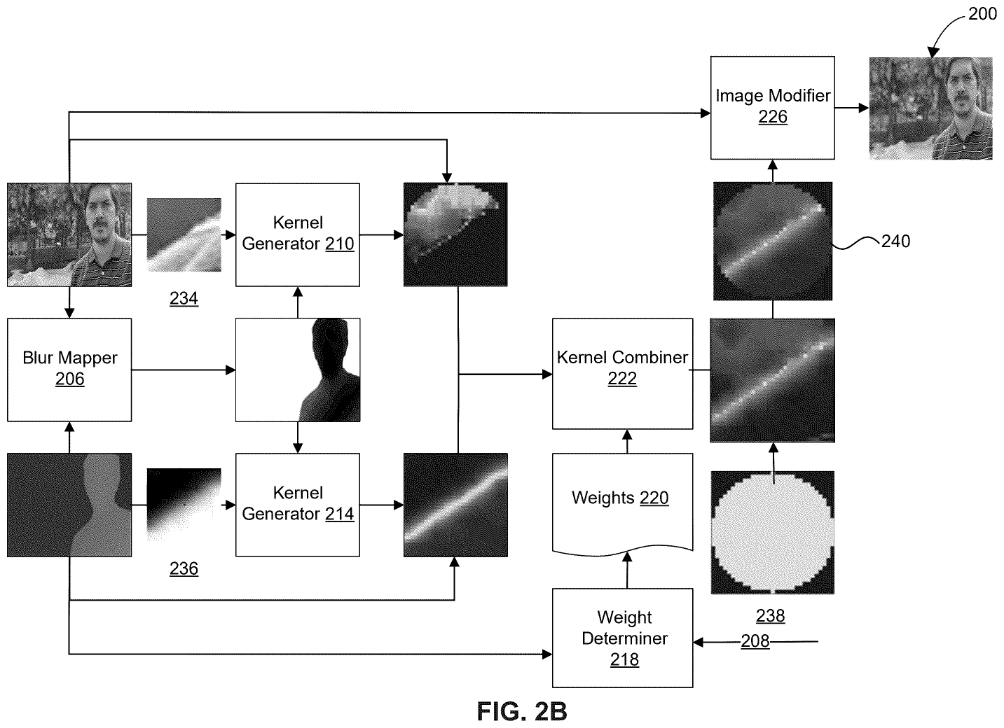

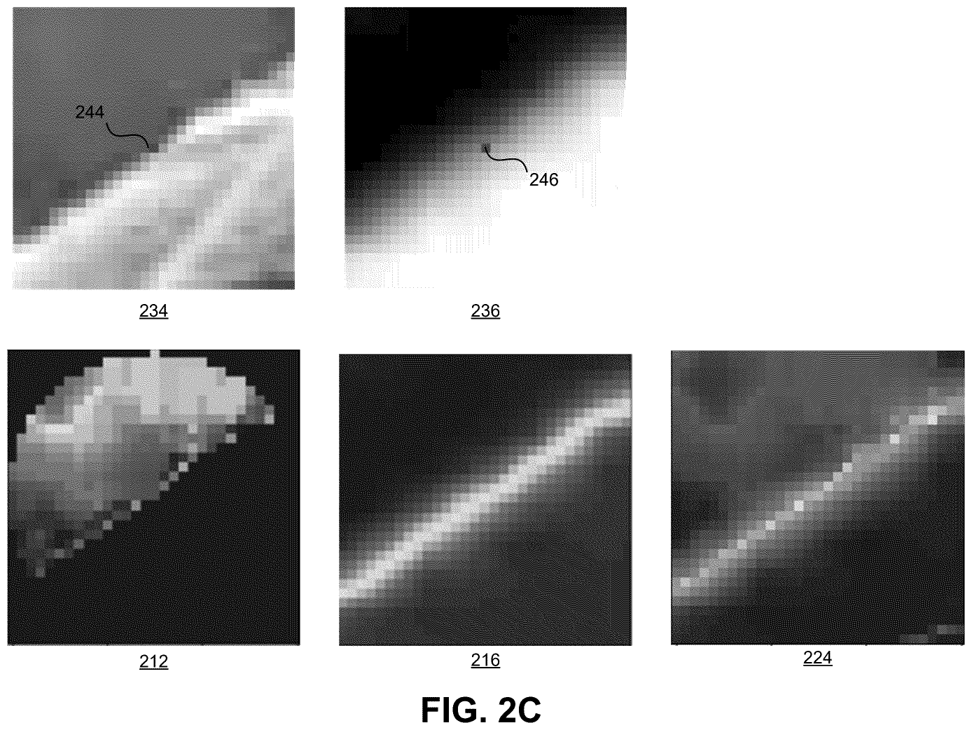

FIG. 2A is a block diagram illustrating an example system 200 for modifying image data, according to various aspects of the present disclosure. A kernel generator 210 of system 200 may generate image-based kernels 212 based on image data 202 and kernel generator 214 of system 200 may generate depth-based kernels 216 based on depth data 204. Kernel combiner 222 may combine image-based kernels 212 and depth-based kernels 216 to generate combined kernels 224. An image modifier 226 may generate modified image data 228 based on image data 202 and combined kernels 224.

Image data 202 may be, or may include, a plurality of pixel values. For example, image data 202 may include 1920×1080 sets of red, green, and blue pixel values. Image data 202 may have any size and be formatted according to any suitable format, including, as examples, red, green, blue (RGB), or luma and chroma (YUV).

Depth data 204 may be, or may include, a plurality of depth values or disparity values. Depth data 204 may represent the same scene that is represented by image data 202. Image data 202 may represent light from the scene. Depth data 204 may represent a distance between a camera and points in a scene (e.g., depths). Additionally or alternatively, depth data 204 may be, or may include, disparity values, for example, representing a disparity between image coordinates of stereoscopically-paired images of the scene. Disparity values may be used to determine depth values based on a predetermined distance between cameras that captured the stereoscopic pair of images. A disparity map is an example of depth information. In the present disclosure, the terms “depth” and “disparity” may be used interchangeably. For example, references to “depth values,” “depth data,” depth information,” and/or “a depth map” may refer to “disparity values,” “disparity data,” disparity information,” and/or “a disparity map.” Also, a reference to “disparity values,” “disparity data,” disparity information,” and/or “a disparity map.” may refer to “depth values,” “depth data,” depth information,” and/or “a depth map.”

There are multiple techniques that can be used to determine depth data 204. For example, according to a phase detection (PD) autofocus-based depth-estimation technique, a device may capture light using two separate sets of photodiodes (or pixels), including image pixels and PD pixels. The device may compare the light as received at the image pixels and the PD pixels to determine how the lens is focused relative to points in the scene. The device may determine depths to the points in the scene (e.g., depth information) based on how the lens is focused relative to the points in the scene.

As another example, according to a depth from stereo (DFS) depth-determination technique, a device may capture two (or more) images of a scene from cameras that are positioned a predetermined distance apart. The device may triangulate depths to points in the scene (e.g., depth information) based on a disparity (e.g., distance) between representations of the points in the two images and the predetermined distance.

According to a time-of-flight (ToF) depth-determination technique, a device may project light into a scene, receive the light as it is reflected from points in the scene, and determine depths of the points in the scene (e.g., depth information) based on the timing of projection and reception of the light.

As another example, according to an active-illumination depth-determination technique, a device may illuminate a scene with patterned light (e.g., a pattern of dots) projected by a projector. The device may capture an image of the scene at a camera that is a predetermined distance from the projector. The device may triangulate depths to points in the scene (e.g., depth information) based on how the patterned light appears in the image of the scene and the predetermined distance.

According to an example machine-learning-model-based depth-estimation technique, a device may capture an image and provide the captured image to a machine-learning model. The machine-learning model may be trained to generate depth information based on images. The machine-learning model may generate depth information based on the provided image. A machine-learning-model-based depth-estimation technique is an example of a monocular depth-estimation technique.

A blur mapper 206 may generate blur map 208 based on image data 202 and depth data 204. For example, blur mapper 206 may divide depth data 204 into layers, with each layer representing a range of depths relative to a focal plane of image data 202. The range may be determined by a factor κ which may be representative of a blur strength to be used to scale the depth range relative to the focal plane.

The value at each location (i, j) in the blur map may represent the blur radius to blur the corresponding pixel in image data 202. In some aspects, the maximum blur radius may be capped, for example, at 15. Blur mapper 206 may compute deltaᵢⱼ=abs(dᵢⱼ−d_{focal}) where delta_{i,j} is the absolute disparity difference between the disparity dᵢⱼ at location (i, j) relative to the disparity at the focal plane d_{focal}. If deltaᵢⱼ=0 then blurmapᵢⱼ=0 since the pixels are on the focal plane. If deltaᵢⱼ is greater than 0 then blurmapᵢⱼ=κ(deltaᵢⱼ−1)+1 where κ is a scaling factor representative of the blur strength. blurmapᵢⱼ=max (blurmapᵢⱼ, 15) i.e., if the blur radius is between 0 and 15 then its original value is retained and if greater than 15, its value is changed to 15.

Blur map 208 may include a blur radius for each pixel of image data 202. A blur radius for a given pixel of image data 202 may indicate a number of pixels of image data 202 to blend with the given pixel when modifying image data 202. Blur map 208 may indicate to blur background pixels of image data 202 and the leave unblurred foreground pixels of image data 202. Blur mapper 206 may identify foreground and background pixels of image data 202 based on depth data 204. For example, pixels of image data 202 may relate to depth values of depth data 204.

The blur radius may describe a shape of a window of pixels to use to blend with the given pixel. The shape may approximate a circle (in pixels). Alternatively, the shape may be another shape, such as a rectangle. A relatively large blur radius of blur map 208, may indicate that the pixel of image data 202 to which the relatively large blur radius corresponds can be blended with a relatively large number of other pixels of image data 202 when determining a new value for the pixel. In contrast, a relatively small blur ratios of blur map 208, may indicate that the pixel of image data 202 to which the relatively large blur radius corresponds can be blended with a relatively small number of other pixels of image data 202 when determining a new value for the pixel. Blur map 208 may include blur radii of zero. For example, pixels of an image that represent a foreground object (e.g., the person of image 102 of FIG. 1) may have a blur radius of zero. A blur radius of zero may indicate that the corresponding pixels are not to be blended when modifying an image (e.g., image 102). In contrast, other pixels (e.g., pixels representing a background of the scene of image 102) may have a relatively large blur radius.

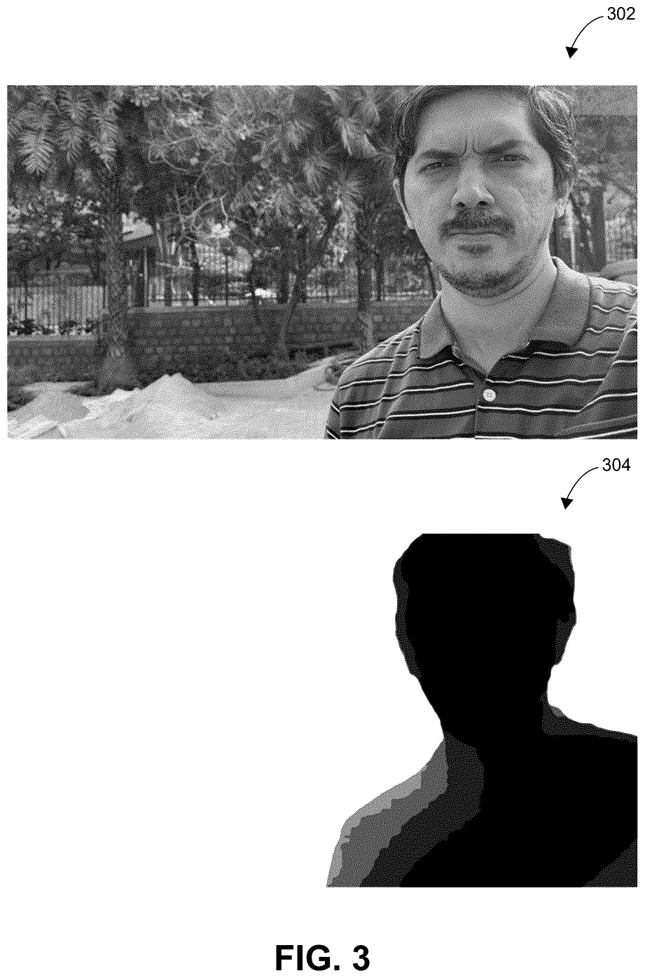

FIG. 3 includes an example image 302 and a corresponding blur map 304, according to various aspects of the present disclosure. Black pixels of blur map 304 may represent blur radii of zero. Lighter pixels of blur map 304 may indicate higher blur radii. White pixels of blur map 304 may represent a maximum blur radius. Blur map 304 may have a maximum blur radius. For example, the maximum blur radius of blur map 304 may be 15, describing a circle of pixels of image 302, with a radius of 15, that may be used to blur a center pixel of the circle.

Blur map 304 can be used to perform an artificial-bokeh technique on image 302. For example, pixels of image 302 may be blended according to blur map 304 to blur a background of image 302. The result of blurring image 302 according to blur map 304 may be image 112 of FIG. 1.

Returning to FIG. 2A, kernel generator 210 may generate image-based kernels 212 based on image data 202 and blur map 208. Kernel generator 210 may generate one of image-based kernels 212 for each pixel of image data 202. The one of image-based kernels 212 for each pixel of image data 202 may be sized based on a corresponding blur radius as indicated by blur map 208. For example, kernel generator 210 may determine a size of a kernel to be twice the blur radius plus one. For example, kernel generator 210 may determine kernelsizeᵢⱼ=2*blurmapᵢⱼ+1 where kernelsizeᵢⱼ represents the size of the kernel used to blur the pixel at location (i, j).

FIG. 2B is a block diagram illustrating system 200 of FIG. 2A including representations of image data 202, depth data 204, and various kernels to illustrate examples of various aspects of the present disclosure. FIG. 2C includes representations of pixel window 234, depth window 236, and various kernels to illustrate examples of various aspects of the present disclosure. FIG. 2B and FIG. 2C include a representation of an example pixel window 234 of image data 202. Pixel window 234 may include intensity values and may, in some instances, omit color values. Pixel window 234 may be based on a pixel 244 of image data 202. For example, pixel window 234 may be a number of pixels surrounding pixel 244. The size of pixel window 234 may depend on the blur radius corresponding to pixel 244 in blur map 208. For example, kernel generator 210 may select pixel window 234 of image data 202 based on a blur radius in blur map 208 that corresponds to pixel 244. In some aspects, kernel generator 210 may select pixel window 234 based on twice the blur radius plus one. For example, kernel generator 210 may select pixel window 234 as a square with sides that are twice the blur radius plus one.

Kernel generator 210 may generate an instance of image-based kernels 212 (e.g., image-based kernel 212) for pixel 244 (e.g., based on pixel window 234). FIG. 2B and FIG. 2C include a representation of an example image-based kernel 212 for pixel 244 of image data 202. Brighter pixels in image-based kernel 212 represent higher weights in image-based kernel 212 and darker pixels represent lower weights in image-based kernel 212. In some aspects, each of image-based kernels 212 may be normalized such that all the values of a given instance of image-based kernels 212 sum to 1.

Kernel generator 210 may generate image-based kernel 212 to have a size based on a blur radius in blur map 208 that corresponds to pixel 244. In some aspects, kernel generator 210 may generate image-based kernel 212 to have a size based on one greater than twice the blur radius corresponding to pixel 244. For example, kernel generator 210 may generate image-based kernel 212 as a square with sides that are twice the blur radius plus one; or kernel generator 210 may generate image-based kernels 212 as a pixelated approximation of a circle with a radius that is twice the blur radius plus one.

Kernel generator 210 may determine an instance of image-based kernels 212 for each pixel location (i, j) (of image data 202) in accordance with difference in intensity relative to the intensity at pixel location (i, j) of image data 202. Mathematically, at each pixel location (i, j) the weight matrix is initialized such that the weights at position (m, n) within it are proportional to:

$$e - \frac{{( {I}_{mn} - {I}_{ij} )}^{2}}{2 {σ}^{2}}$$

$$where σ is a constant which is determined emperically ;$$

$$where {I}_{ij} = intensity of pixel ( i , j ) ;$$

$$where 0 \leq i < height of image ;$$

$$where 0 \leq j < width of image ;$$

$$where {I}_{mn} = intensity of neighborhood pixels ( m , n ) ;$$

$$where ( i + {p}_{max} - blur radius ) \leq m \leq ( i + {p}_{max} + blur radius ) ,$$

$$( j + {p}_{max} - blur radius ) \leq n \leq ( j + {p}_{max} + blur radius ) ;$$

$$where {p}_{max} is the padding which corresponds to the maximum blur radius .$$

Returning to FIG. 2A, kernel generator 214 may generate depth-based kernels 216 based on depth data 204 and blur map 208. Kernel generator 214 may generate one of depth-based kernels 216 for each depth value of depth data 204. The one of depth-based kernels 216 for each depth value of depth data 204 may be sized based on a corresponding blur radius as indicated by blur map 208. For example, kernel generator 214 may determine a size of a kernel to be twice the blur radius plus one. For example, kernel generator 214 may determine kernelsizeᵢⱼ=2*blurmapᵢⱼ+1 where kernelsizeᵢⱼ represents the size of the kernel used to blur the pixel at location (i,j).

FIG. 2B and FIG. 2C include a representation of an example depth window 236 of depth data 204. Depth window 236 may include depth values or disparity values. Lighter pixels in depth window 236 may represent points in the scene that are closer to the camera that captured image data 202 and darker pixels in depth window 236 may represent points in the scene that are farther from the camera.

Depth window 236 may be based on a depth value 246 of depth data 204. Depth value 246 may correspond to pixel 244. For example, if image data 202 and depth data 204 have the same dimensions, pixel 244 and depth value 246 may have the same coordinates. Alternatively, if image data 202 and depth data 204 have different dimensions, the coordinates of pixel 244 and depth value 246 may relate based on a scale ratio between the dimensions of image data 202 and the dimensions of depth data 204. Pixel 244 and depth value 246 may represent the substantially same point in the scene.

Depth window 236 may be a number of depth values surrounding depth value 246. The size of depth window 236 may depend on the blur radius corresponding to depth value 246 in blur map 208. For example, kernel generator 214 may select depth window 236 of depth data 204 based on a blur radius in blur map 208 that corresponds to depth value 246. In some aspects, kernel generator 214 may select depth window 236 based on twice the blur radius plus one. For example, kernel generator 214 may select depth window 236 as a square with sides that are twice the blur radius plus one.

Kernel generator 214 may generate an instance of depth-based kernels 216 (e.g., depth-based kernel 216) for depth value 246 (e.g., based on depth window 236). FIG. 2B and FIG. 2C include a representation of an example depth window 236 for depth value 246 of depth data 204. Brighter pixels in depth-based kernel 216 represent higher weights in depth-based kernel 216 and darker pixels represent lower weights in depth-based kernel 216. In some aspects, each of depth-based kernels 216 may be normalized such that all the values of a given one of depth-based kernels 216 sum to 1.

Kernel generator 214 may generate depth-based kernel 216 to have a size based on a blur radius in blur map 208 that corresponds to depth value 246. In some aspects, kernel generator 214 may generate depth-based kernel 216 to have a size based on one greater than twice the blur radius corresponding to depth value 246. For example, kernel generator 214 may generate depth-based kernel 216 as a square with sides that are twice the blur radius plus one; or kernel generator 214 may generate depth-based kernel 216 as a pixelated approximation of a circle with a radius that is twice the blur radius plus one.

Kernel generator 214 may determine depth-based kernels 216 for each pixel location (i, j) (of image data 202) in accordance with difference in disparity (or depth) relative to the disparity (or depth) at pixel location (i, j) of depth data 204. Mathematically, at each pixel location (i, j) the weight matrix is initialized such that the weights at position (m, n) within it are proportional to:

$$e - \frac{{( {d}_{mn} - {d}_{ij} )}^{2}}{2 {σ}^{2}}$$

$$where σ is a constant which is determined empirically ;$$

$$where {d}_{ij} = disparity of pixel ( i , j ) ;$$

$$where 0 \leq i < height of image ;$$

$$where 0 \leq j < width of image ;$$

$$where {d}_{mn} = disparity of neighborhood pixels ( m , n ) ;$$

$$where ( i + {p}_{max} - blur radius ) \leq m \leq ( i + {p}_{max} + blur radius ) ,$$

$$( j + {p}_{max} - blur radius ) \leq n \leq ( j + {p}_{max} + blur radius ) ;$$

$$where {p}_{max} is the padding which corresponds to the maximum blur radius .$$

Returning to FIG. 2A, kernel combiner 222 may combine each of image-based kernels 212 with a corresponding one of depth-based kernels 216 to generate combined kernels 224. For example, for kernel generator 210 may generate one of image-based kernels 212 for each pixel of image data 202. Likewise, kernel generator 214 may generate one of depth-based kernels 216 for each depth value of depth data 204. In some aspects, the number of image-based kernels 212 and the number of depth-based kernels 216 may be the same. In other aspects, the number of image-based kernels 212 and the number of depth-based kernels 216 may not be the same. In such cases, image-based kernels 212 and depth-based kernels 216 may be interrelated, for example, based on a relationship (e.g., a spatial relationship in image data 202 and depth data 204) between the pixels and depth values on which image-based kernels 212 and depth-based kernels 216 are based. In any case, kernel combiner 222 may generate combined kernels 224 based on image-based kernels 212 and depth-based kernels 216. Each of combined kernels 224 may be based on one of image-based kernels 212 and one of depth-based kernels 216. There may be one of combined kernels 224 for each pixel in image data 202.

Kernel combiner 222 may perform a weighted average to combine image-based kernels 212 and depth-based kernels 216. For example, kernel combiner 222 may multiply all the weight values of a given one of image-based kernels 212 by a first weight and multiply all the weight values of a corresponding one of depth-based kernels 216 by a second weight. Kernel combiner 222 may sum the product of the given one of image-based kernels 212 and the first weight with the product of the corresponding one of depth-based kernels 216 and the second weight. Kernel combiner 222 may normalize the sum (e.g., by dividing the sum by the sum of the first weight and the second weight.

For the weighted averaging, the weight of depth-based kernels 216 may be based on a constant. For example, kernel combiner 222 may apply the same weight to all of depth-based kernels 216 when performing the weighted averaging of image-based kernels 212 and depth-based kernels 216.

For the weighted averaging, the weight of a given kernel of image-based kernels 212 may be based on a likelihood that the window on which the given kernel is based depicts a boundary between foreground and background. Weight determiner 218 may, for the weighted averaging, weight kernels representing boundaries between foreground and background higher than pixels representing either foreground alone or background alone.

For example, for each pixel of image data 202, weight determiner 218 may determine a likelihood that a window of pixels surrounding the window represents a boundary between foreground and background. Weight determiner 218 may determine the likelihood based on depth data 204 and/or blur map 208. For example, a window including large depth values (relative to the other depth values of depth data 204), may be determined to be representative of a background, a window including small depth values (relative to the other depth values of depth data 204), may be determined to be representative of a foreground, and a window including both large and small and depth values, may be determined to be representative of a boundary between foreground and background. Additionally or alternatively, a window including a wide disparity of depth values (of the depth values of the window) may be determined to be representative of a boundary between foreground and background. As another example, a window including large bur radii (relative to the other blur radii of blur map 208), may be determined to be representative of a background, a window including small blur radii (relative to the other bur radii of blur map 208), may be determined to be representative of a foreground, and a window including both large and small bur radii, may be determined to be representative of a boundary between foreground and background.

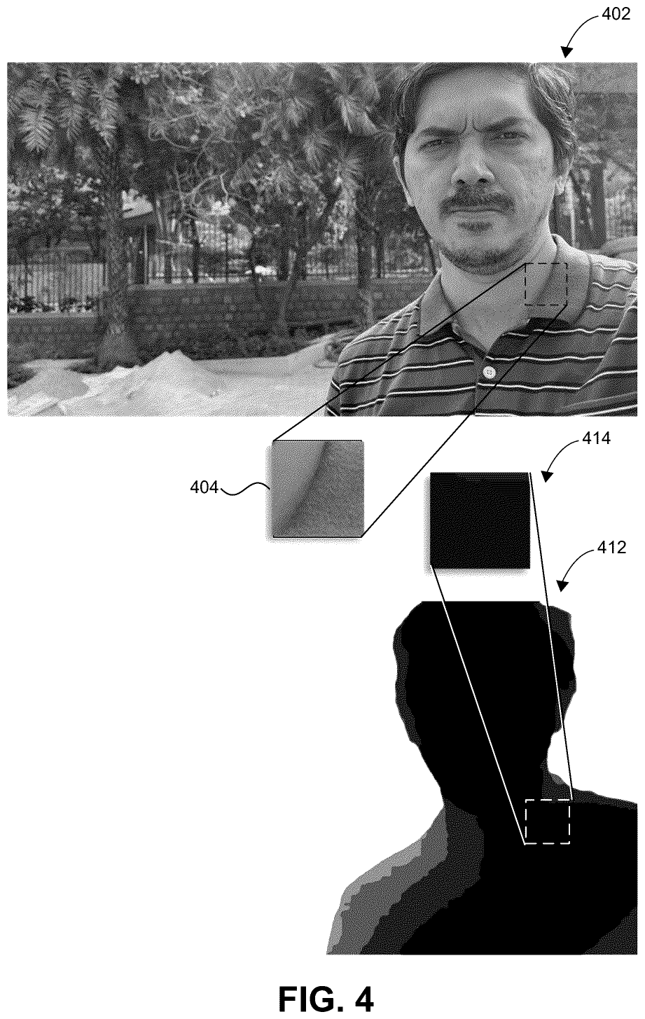

FIG. 4 includes an example image 402 and an example blur map 412, according to various aspects of the present disclosure. Inset 404 illustrates a window of pixels of image 402. Inset 414 illustrates a window of blur radii of blur map 412. Weight determiner 218 may determine that a center pixel of inset 404 represents a foreground based on the relatively small blur radii of inset 414.

Inset 404 includes variation in intensity. Weight determiner 218 may determine that inset 404 does not depict a boundary between foreground and background because inset 414 is more or less uniform in intensity. For example, weight determiner 218 may determine a standard deviation of blur radii of inset 414 and determine that inset 414 is does not represent a boundary between foreground and background based on the standard deviation not exceeding a threshold.

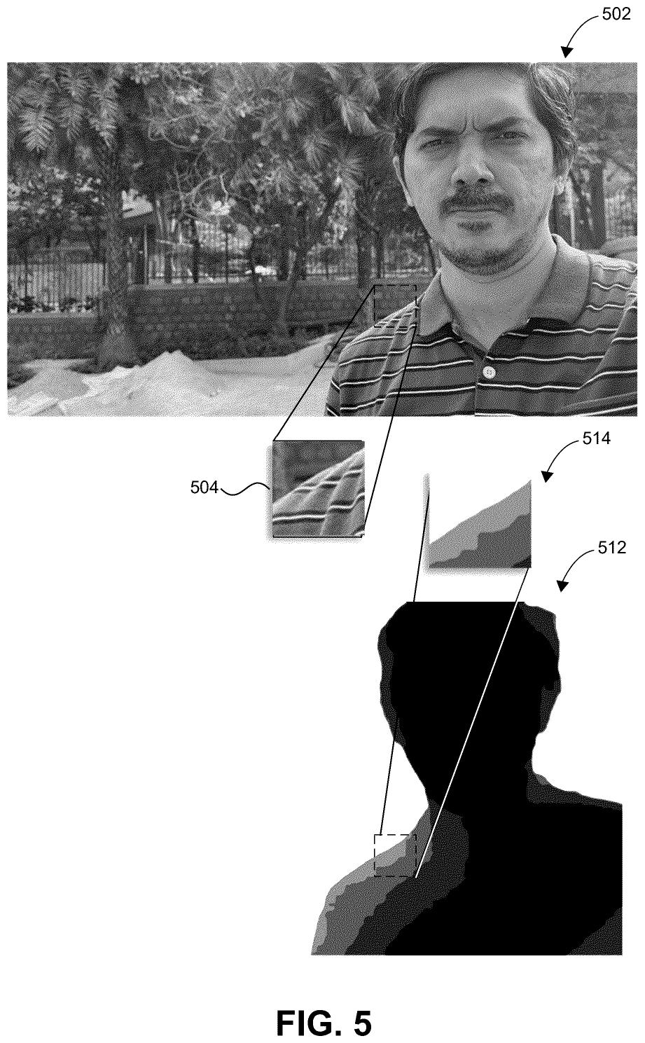

FIG. 5 includes an example image 502 and an example blur map 512, according to various aspects of the present disclosure. Inset 504 illustrates a window of pixels of image 502. Inset 514 illustrates a window of blur radii of blur map 512. Weight determiner 218 may determine that a center pixel of inset 504 represents boundary between foreground and background based on the relatively small and the relatively large blur radii of inset 514.

Inset 504 includes variation in intensity (similar to inset 404 of FIG. 4). Weight determiner 218 may determine that inset 504 depicts a boundary between foreground and background because inset 514 has a wide range of blur radii. For example, weight determiner 218 may determine that inset 514 includes discontinuities. For instance, weight determiner 218 may determine a standard deviation of blur radii of inset 514 and determine that inset 514 represents a boundary between foreground and background based on the standard deviation exceeding a threshold.

Comparing FIG. 2B, FIG. 2C, and FIG. 5, depth window 236 may result in blur map portion that is similar to inset 514 based on depth window 236 including foreground depth values and background depth values. Continuing with the examples of FIG. 2B and FIG. 2C, weight determiner 218 may determine that image-based kernel 212 (which is based on pixel window 234, which is relates to depth window 236) represents a boundary between foreground and background based on depth window 236 including a wide range of depth values. Accordingly, when weight determiner 218 determines a weight for image-based kernel 212 (to perform the weighted averaging of image-based kernels 212 and depth-based kernels 216), weight determiner 218 may determine the weight for image-based kernel 212 based on image-based kernel 212 being a boundary between foreground and background. Weight determiner 218 may (when performing weighted averaging) weight kernels based on windows representing boundaries between foreground and background higher than kernels based on windows representing either foreground alone or background alone. Thus, the weight, applied in weighted averaging, of image-based kernel 212 may be based on a likelihood that image-based kernel 212 represents a boundary between foreground and background.

Weight determiner 218 may determine a weight (of weights 220) for each pixel of image data 202. For example, for each pixel of image data 202, weight determiner 218 may identify a window of depth data 204 (or of blur map 208) and determine a likelihood that the window represents a boundary between foreground and background. Weight determiner 218 may determine a weight (of weights 220) for each pixel of image data 202 based on the likelihood that the corresponding window represents a boundary between foreground and background. Kernel combiner 222 may perform a weighted averaging of image-based kernels 212 and depth-based kernels 216 based on weights 220. For example, kernel combiner 222 may apply a constant weight to each of depth-based kernels 216 and a respective weight of weights 220 to each of image-based kernels 212. Kernel combiner 222 may determine each of combined kernels 224 based on a weighted average of a corresponding one of image-based kernels 212 and a corresponding one of depth-based kernels 216.

Based on the example case of FIG. 2B and FIG. 2C, weight determiner 218 may determine a weight for image-based kernel 212 based on depth window 236 representing a boundary between foreground and background. Kernel combiner 222 may apply the weight when averaging image-based kernel 212 with a corresponding one of depth-based kernels 216 to generate a corresponding one of combined kernels 224.

Returning to FIG. 2B, in some aspects, kernel combiner 222 may apply a mask 238 to combined kernels 224 and normalize the resulting kernel to generate kernel 240. Mask 238 may be based on blur map 208. For example, an instance of mask 238 may be determined each combined kernels 224 based on a blur radius related to the pixel on which combined kernels 224 was based. In such cases, image modifier 226 may modify image data 202 based on kernel 240.

Returning to FIG. 2A, image modifier 226 may modify image data 202 using combined kernels 224 to generate modified image data 228. For example, for each pixel of image data 202, image modifier 226 may multiply a window of pixels of image data 202 with a kernel from combined kernels 224 that relates to the pixel. Image modifier 226 may sum the product to determine a new value for the pixel. Image modifier 226 may use a respective kernel of combined kernels 224 for each pixel of image data 202. Image modifier 226 may perform an artificial-bokeh technique on image data 202 using combined kernels 224.

Returning to FIG. 2C, when image modifier 226 modifies image data 202 based on combined kernels 224, combined kernels 224 can pick foreground pixels. Blending foreground pixels with background pixels may result in halo, for example, as illustrated and described with regard to FIG. 1. Kernel combiner 222 can generate combined kernels 224 such that combined kernels 224 increase the weight of background pixels and decrease the weight of foreground pixels (e.g., to zero or near zero).

Since depth window 236 indicates that depth value 246 partially lies in both foreground and background, depth-based kernels 216 include weights for pixels from the foreground as well as pixels from the background. The weights that correspond to foreground pixels may cause color halo. Because kernel combiner 222 combines image-based kernels 212 with depth-based kernels 216 to generate combined kernels 224, combined kernels 224 picks the pixel mostly from the background and avoids pixels from the foreground.

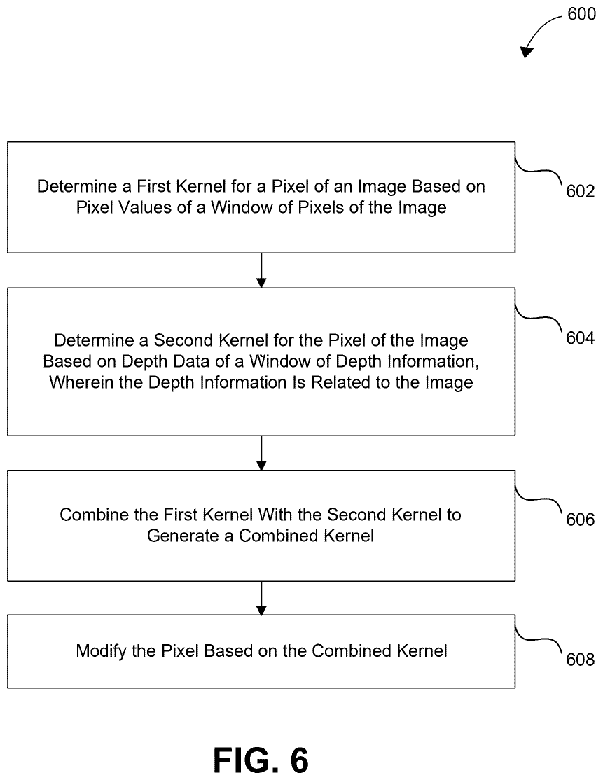

FIG. 6 is a flow diagram illustrating an example process 600 for modifying an image, in accordance with aspects of the present disclosure. One or more operations of process 600 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 600. The one or more operations of process 600 may be implemented as software components that are executed and run on one or more processors.

At block 602, a computing device (or one or more components thereof) may determine a first kernel for a pixel of an image based on pixel values of a window of pixels of the image. For example, kernel generator 210 may generate an image-based kernel 212 for a pixel 244 of image data 202 based on pixel values of a pixel window 234 of pixels of image data 202.

In some aspects, to determine the first kernel, computing device (or one or more components thereof) may compare a respective pixel value of each pixel of the window of pixels to pixel values of pixels of the window of pixels to determine a respective weight of the first kernel. For example, to determine image-based kernel 212, kernel generator 210 may compare the value of pixel 244 to the values of all the pixels of pixel window 234.

At block 604, the computing device (or one or more components thereof) may determine a second kernel for the pixel of the image based on depth data of a window of depth information, wherein the depth information is related to the image. For example, kernel generator 214 may generate a depth-based kernel 216 for pixel 244 of image data 202 based on depth data of depth window 236 of depth data 204. Image data 202 and depth data 204 may represent the same scene.

In some aspects, to determine the second kernel, the computing device (or one or more components thereof) may compare a respective depth value of each depth of the window of depth information to depth values of depths of the window of depth information to determine a respective weight of the second kernel. For example, to determine depth-based kernels 216, kernel generator 214 may compare the value of depth value 246 with all the other depth values of depth window 236.

In some aspects, the depth data may be, or may include, depth values and the depth information may be, or may include, a depth map. For example, depth data 204 may be, or may include, a depth map including a plurality of depth values.

In some aspects, the depth data may be, or may include, disparity values and the depth information may be, or may include, a disparity map. For example, depth data 204 may be, or may include, a disparity map including a plurality of disparity values.

In some aspects, the computing device (or one or more components thereof) may determine a blur radius for the pixel. In such aspects, a size of the first kernel may be based on the blur radius; a size of the window of pixels may be based on the blur radius; a size of the second kernel may be based on the blur radius; and a size of the window of depth information may be based on the blur radius. For example, blur mapper 206 may generate blur map 208 based on depth data 204. Kernel generator 210 may generate image-based kernels 212 such that a size of image-based kernels 212, and/or a size of pixel window 234 is based on a blur radius corresponding to pixel 244. Kernel generator 214 may generate depth-based kernels 216 such that a size of depth-based kernels 216 and/or a size of depth window 236 is based on a blur radius corresponding to pixel 244.

In some aspects, the blur radius for the pixel may be based on depth data related to the pixel. For example, the blur radius corresponding to pixel 244 may be based on depth value 246 and/or depth values of depth window 236.

In some aspects, the blur radius for the pixel may be determined based on a relationship between depth ranges and blur radii. For example, blur mapper 206 may determine depth radii for various pixels of image data 202 based on a function correlating depth values of depth data 204 corresponding to the various pixels of image data 202 to blur radii.

At block 606, the computing device (or one or more components thereof) may combine the first kernel with the second kernel to generate a combined kernel. For example, kernel combiner 222 may combine the image-based kernel 212 determined at block 602 with the depth-based kernel 216 determined at block 604 to generate a combined kernel 224.

In some aspects, to combine the first kernel with the second kernel to generate the combined kernel, the computing device (or one or more components thereof) may determine a weighted average of the first kernel and the second kernel. For example, kernel combiner 222 may determine a weighted average of image-based kernel 212 and depth-based kernel 216.

In some aspects, in the weighted average, the first kernel is weighted based on a depth value related to the pixel. For example, when combining image-based kernel 212 and depth-based kernel 216, kernel combiner 222 may determine a weighted average of image-based kernel 212 and depth-based kernel 216. Further, in determining the weighted average, kernel combiner 222 may weight image-based kernels 212 based on depth value 246 which is related to pixel 244.

At block 608, the computing device (or one or more components thereof) may modify the pixel based on the combined kernel. For example, image modifier 226 may modify image data 202 based on the combined kernel 224 generated at block 606.

In some aspects, to modify the pixel based on the combined kernel, the computing device (or one or more components thereof) may sum a product of weights of the combined kernel and the pixel values of the window of pixels. For example, image modifier 226 may multiply weights of combined kernel 224 with pixels of a window of pixels of image data 202 surrounding pixel 244. Further image modifier 226 may sum the products and normalize the value to determine a new value for pixel 244.

In some aspects, the pixel (for which the first kernel is determined at block 602 for which the second kernels is determined at block 604, for which the combined kernel is determined at block 606 and which is modified at block 608) may be a first pixel. The window of pixels (based on which the first kernel is determined at block 602) may be a first window of pixels. The window of depth information (based on which the second kernel is determined at block 604) may be a first window of depth information. The combined kernel (determined at block 606) may be a first combined kernel. The computing device (or one or more components thereof) may determine a third kernel for a second pixel of the image based on pixel values of a second window of pixels of the image; determine a fourth kernel for the second pixel of the image based on depth data of a second window of depth information; and combine the third kernel with the fourth kernel to generate a second combined kernel; and modify the second pixel based on the second combined kernel. For example, system 200 may repeat block 602, block 604, block 606, and block 608 for a second pixel of image data 202.

In some aspects, the computing device (or one or more components thereof) may determine a plurality of first kernels, each first kernel of the plurality of first kernels corresponding to a respective pixel of a plurality of pixels of an image; determine a plurality of second kernels, each second kernel of the plurality of second kernels corresponding to a respective pixel of the plurality of pixels of the image; combine each first kernel of the plurality of first kernels with a corresponding second kernel of the plurality of second kernels to generate a plurality of combined kernels, each combined kernel of the plurality of combined kernels corresponding to a respective pixel of the plurality of pixels of the image; and modify each pixel of the plurality of pixels of the image based on a respective combined kernel of the plurality of combined kernels to generate a modified image. For example, system 200 may repeat block 602, block 604, block 606, and block 608 for a plurality of pixels of image data 202.

In some aspects, the computing device (or one or more components thereof) may store the modified image; display the modified image; process the modified image; and/or transmit the modified image. For example, system 200 may store, display, process, and/or transmit modified image data 228.

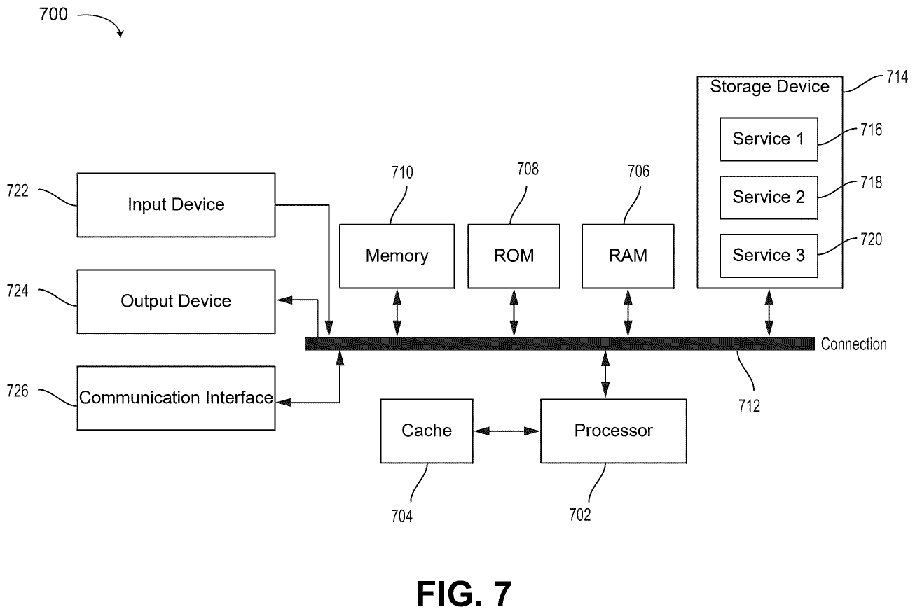

In some examples, as noted previously, the methods described herein (e.g., process 600 of FIG. 6, and/or other methods described herein) can be performed, in whole or in part, by a computing device or apparatus. In one example, one or more of the methods can be performed by the system 200 of FIG. 2A and/or FIG. 2B, or by another system or device. In another example, one or more of the methods (e.g., process 600, and/or other methods described herein) can be performed, in whole or in part, by the computing-device architecture 700 shown in FIG. 7. For instance, a computing device with the computing-device architecture 700 shown in FIG. 7 can include, or be included in, the components of the system 200 of FIG. 2A and/or FIG. 2B and can implement the operations of process 600, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 600, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 600, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 7 illustrates an example computing-device architecture 700 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 700 may include, implement, or be included in any or all of the system 200 of FIG. 2A and/or 2B and/or other devices, modules, or systems described herein. Additionally or alternatively, computing-device architecture 700 may be configured to perform process 600, and/or other process described herein.

The components of computing-device architecture 700 are shown in electrical communication with each other using connection 712, such as a bus. The example computing-device architecture 700 includes a processing unit (CPU or processor) 702 and computing device connection 712 that couples various computing device components including computing device memory 710, such as read only memory (ROM) 708 and random-access memory (RAM) 706, to processor 702.

Computing-device architecture 700 can include a cache of high-speed memory connected directly with, in close proximity to, or integrated as part of processor 702. Computing-device architecture 700 can copy data from memory 710 and/or the storage device 714 to cache 704 for quick access by processor 702. In this way, the cache can provide a performance boost that avoids processor 702 delays while waiting for data. These and other modules can control or be configured to control processor 702 to perform various actions. Other computing device memory 710 may be available for use as well. Memory 710 can include multiple different types of memory with different performance characteristics. Processor 702 can include any general-purpose processor and a hardware or software service, such as service 1 716, service 2 718, and service 3 720 stored in storage device 714, configured to control processor 702 as well as a special-purpose processor where software instructions are incorporated into the processor design. Processor 702 may be a self-contained system, containing multiple cores or processors, a bus, memory controller, cache, etc. A multi-core processor may be symmetric or asymmetric.

To enable user interaction with the computing-device architecture 700, input device 722 can represent any number of input mechanisms, such as a microphone for speech, a touch-sensitive screen for gesture or graphical input, keyboard, mouse, motion input, speech and so forth. Output device 724 can also be one or more of a number of output mechanisms known to those of skill in the art, such as a display, projector, television, speaker device, etc. In some instances, multimodal computing devices can enable a user to provide multiple types of input to communicate with computing-device architecture 700. Communication interface 726 can generally govern and manage the user input and computing device output. There is no restriction on operating on any particular hardware arrangement and therefore the basic features here may easily be substituted for improved hardware or firmware arrangements as they are developed.

Storage device 714 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 706, read only memory (ROM) 708, and hybrids thereof. Storage device 714 can include services 716, 718, and 720 for controlling processor 702. Other hardware or software modules are contemplated. Storage device 714 can be connected to the computing device connection 712. In one aspect, a hardware module that performs a particular function can include the software component stored in a computer-readable medium in connection with the necessary hardware components, such as processor 702, connection 712, output device 724, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, universal serial bus (USB) devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for modifying image data, the apparatus comprising: at least one memory; and at least one processor coupled to the at least one memory and configured to: determine a first kernel for a pixel of an image based on pixel values of a window of pixels of the image; determine a second kernel for the pixel of the image based on depth data of a window of depth information, wherein the depth information is related to the image; combine the first kernel with the second kernel to generate a combined kernel; and modify the pixel based on the combined kernel.
Aspect 2. The apparatus of aspect 1, wherein the at least one processor is configured to determine a blur radius for the pixel, wherein: a size of the first kernel is based on the blur radius; a size of the window of pixels is based on the blur radius; a size of the second kernel is based on the blur radius; and a size of the window of depth information is based on the blur radius.
Aspect 3. The apparatus of aspect 2, wherein the blur radius for the pixel is based on depth data related to the pixel.
Aspect 4. The apparatus any one of aspects 2 or 3, wherein the blur radius for the pixel is determined based on a relationship between depth ranges and blur radii.
Aspect 5. The apparatus of any one of aspects 1 to 4, wherein, to determine the first kernel, the at least one processor is configured to compare a respective pixel value of each pixel of the window of pixels to pixel values of pixels of the window of pixels to determine a respective weight of the first kernel.
Aspect 6. The apparatus of any one of aspects 1 to 5, wherein, to determine the second kernel, the at least one processor is configured to compare a respective depth value of each depth of the window of depth information to depth values of depths of the window of depth information to determine a respective weight of the second kernel.
Aspect 7. The apparatus of any one of aspects 1 to 6, wherein, to combine the first kernel with the second kernel to generate the combined kernel, the at least one processor is configured to determine a weighted average of the first kernel and the second kernel.
Aspect 8. The apparatus of aspect 7, wherein, in the weighted average, the first kernel is weighted based on a depth value related to the pixel.
Aspect 9. The apparatus of any one of aspects 1 to 8, wherein, to modify the pixel based on the combined kernel, the at least one processor is configured to sum a product of weights of the combined kernel and the pixel values of the window of pixels.
Aspect 10. The apparatus of any one of aspects 1 to 9, wherein: the pixel comprises a first pixel; the window of pixels comprises a first window of pixels; the window of depth information comprises a first window of depth information; and the combined kernel comprises a first combined kernel; wherein the at least one processor is configured to: determine a third kernel for a second pixel of the image based on pixel values of a second window of pixels of the image; determine a fourth kernel for the second pixel of the image based on depth data of a second window of depth information; combine the third kernel with the fourth kernel to generate a second combined kernel; and modify the second pixel based on the second combined kernel.
Aspect 11. The apparatus of any one of aspects 1 to 10, wherein the at least one processor is configured to: determine a plurality of first kernels, each first kernel of the plurality of first kernels corresponding to a respective pixel of a plurality of pixels of an image; determine a plurality of second kernels, each second kernel of the plurality of second kernels corresponding to a respective pixel of the plurality of pixels of the image; combine each first kernel of the plurality of first kernels with a corresponding second kernel of the plurality of second kernels to generate a plurality of combined kernels, each combined kernel of the plurality of combined kernels corresponding to a respective pixel of the plurality of pixels of the image; and modify each pixel of the plurality of pixels of the image based on a respective combined kernel of the plurality of combined kernels to generate a modified image.
Aspect 12. The apparatus of aspect 11, wherein the at least one processor is configured to at least one of: store the modified image; display the modified image; process the modified image; or transmit the modified image.
Aspect 13. The apparatus of any one of aspects 1 to 12, wherein the depth data comprises depth values and wherein the depth information comprises a depth map.
Aspect 14. The apparatus of any one of aspects 1 to 13, wherein the depth data comprises disparity values and wherein the depth information comprises a disparity map.
Aspect 15. A method for modifying image data, the method comprising: determining a first kernel for a pixel of an image based on pixel values of a window of pixels of the image; determining a second kernel for the pixel of the image based on depth data of a window of depth information, wherein the depth information is related to the image; combining the first kernel with the second kernel to generate a combined kernel; and modifying the pixel based on the combined kernel.
Aspect 16. The method of aspect 15, further comprising determining a blur radius for the pixel, wherein: a size of the first kernel is based on the blur radius; a size of the window of pixels is based on the blur radius; a size of the second kernel is based on the blur radius; and a size of the window of depth information is based on the blur radius.
Aspect 17. The method of aspect 16, wherein the blur radius for the pixel is based on depth data related to the pixel.
Aspect 18. The method of any one of aspects 16 or 17, wherein the blur radius for the pixel is determined based on a relationship between depth ranges and blur radii.
Aspect 19. The method of any one of aspects 15 to 18, wherein determining the first kernel comprises comparing a respective pixel value of each pixel of the window of pixels to pixel values of pixels of the window of pixels to determine a respective weight of the first kernel.
Aspect 20. The method of any one of aspects 15 to 19, wherein determining the second kernel comprises comparing a respective depth value of each depth of the window of depth information to depth values of depths of the window of depth information to determine a respective weight of the second kernel.
Aspect 21. The method of any one of aspects 15 to 20, wherein combining the first kernel with the second kernel to generate the combined kernel comprises determining a weighted average of the first kernel and the second kernel.
Aspect 22. The method of aspect 21, wherein, in the weighted average, the first kernel is weighted based on a depth value related to the pixel.
Aspect 23. The method of any one of aspects 15 to 22, wherein modifying the pixel based on the combined kernel comprises summing a product of weights of the combined kernel and the pixel values of the window of pixels.
Aspect 24. The method of any one of aspects 15 to 23, wherein: the pixel comprises a first pixel; the window of pixels comprises a first window of pixels; the window of depth information comprises a first window of depth information; and the combined kernel comprises a first combined kernel; the method further comprising: determining a third kernel for a second pixel of the image based on pixel values of a second window of pixels of the image; determining a fourth kernel for the second pixel of the image based on depth data of a second window of depth information; combining the third kernel with the fourth kernel to generate a second combined kernel; and modifying the second pixel based on the second combined kernel.
Aspect 25. The method of any one of aspects 15 to 24, further comprising: determining a plurality of first kernels, each first kernel of the plurality of first kernels corresponding to a respective pixel of a plurality of pixels of an image; determining a plurality of second kernels, each second kernel of the plurality of second kernels corresponding to a respective pixel of the plurality of pixels of the image; combining each first kernel of the plurality of first kernels with a corresponding second kernel of the plurality of second kernels to generate a plurality of combined kernels, each combined kernel of the plurality of combined kernels corresponding to a respective pixel of the plurality of pixels of the image; and modifying each pixel of the plurality of pixels of the image based on a respective combined kernel of the plurality of combined kernels to generate a modified image.
Aspect 26. The method of aspect 25, further comprising at least one of: storing the modified image; displaying the modified image; processing the modified image; or transmitting the modified image.
Aspect 27. The method of any one of aspects 15 to 26, wherein the depth data comprises depth values and wherein the depth information comprises a depth map.
Aspect 28. The method of any one of aspects 15 to 27, wherein the depth data comprises disparity values and wherein the depth information comprises a disparity map.
Aspect 29. A non-transitory computer-readable storage medium having stored thereon instructions that, when executed by at least one processor, cause the at least one processor to perform operations according to any of aspects 15 to 28.
Aspect 30. An apparatus for providing virtual content for display, the apparatus comprising one or more means for perform operations according to any of aspects 15 to 28.

What is claimed is:

1. An apparatus for modifying image data, the apparatus comprising:
at least one memory; and
at least one processor coupled to the at least one memory and configured to:
determine a first kernel for a pixel of an image based on pixel values of a window of pixels of the image;
determine a second kernel for the pixel of the image based on depth data of a window of depth information, wherein the depth information is related to the image;
combine the first kernel with the second kernel to generate a combined kernel; and
modify the pixel based on the combined kernel.

2. The apparatus of claim 1, wherein the at least one processor is configured to determine a blur radius for the pixel, wherein:
a size of the first kernel is based on the blur radius;
a size of the window of pixels is based on the blur radius;
a size of the second kernel is based on the blur radius; and
a size of the window of depth information is based on the blur radius.

3. The apparatus of claim 2, wherein the blur radius for the pixel is based on depth data related to the pixel.

4. The apparatus of claim 2, wherein the blur radius for the pixel is determined based on a relationship between depth ranges and blur radii.

5. The apparatus of claim 1, wherein, to determine the first kernel, the at least one processor is configured to compare a respective pixel value of each pixel of the window of pixels to pixel values of pixels of the window of pixels to determine a respective weight of the first kernel.

6. The apparatus of claim 1, wherein, to determine the second kernel, the at least one processor is configured to compare a respective depth value of each depth of the window of depth information to depth values of depths of the window of depth information to determine a respective weight of the second kernel.

7. The apparatus of claim 1, wherein, to combine the first kernel with the second kernel to generate the combined kernel, the at least one processor is configured to determine a weighted average of the first kernel and the second kernel.

8. The apparatus of claim 7, wherein, in the weighted average, the first kernel is weighted based on a depth value related to the pixel.

9. The apparatus of claim 1, wherein, to modify the pixel based on the combined kernel, the at least one processor is configured to sum a product of weights of the combined kernel and the pixel values of the window of pixels.

10. The apparatus of claim 1, wherein:
the pixel comprises a first pixel;
the window of pixels comprises a first window of pixels;
the window of depth information comprises a first window of depth information; and
the combined kernel comprises a first combined kernel;
wherein the at least one processor is configured to:
determine a third kernel for a second pixel of the image based on pixel values of a second window of pixels of the image;
determine a fourth kernel for the second pixel of the image based on depth data of a second window of depth information;
combine the third kernel with the fourth kernel to generate a second combined kernel; and
modify the second pixel based on the second combined kernel.

11. The apparatus of claim 1, wherein the at least one processor is configured to:
determine a plurality of first kernels, each first kernel of the plurality of first kernels corresponding to a respective pixel of a plurality of pixels of an image;
determine a plurality of second kernels, each second kernel of the plurality of second kernels corresponding to a respective pixel of the plurality of pixels of the image;
combine each first kernel of the plurality of first kernels with a corresponding second kernel of the plurality of second kernels to generate a plurality of combined kernels, each combined kernel of the plurality of combined kernels corresponding to a respective pixel of the plurality of pixels of the image; and
modify each pixel of the plurality of pixels of the image based on a respective combined kernel of the plurality of combined kernels to generate a modified image.

12. The apparatus of claim 11, wherein the at least one processor is configured to at least one of:
store the modified image;
display the modified image;
process the modified image; or
transmit the modified image.

13. The apparatus of claim 1, wherein the depth data comprises depth values and wherein the depth information comprises a depth map.

14. The apparatus of claim 1, wherein the depth data comprises disparity values and wherein the depth information comprises a disparity map.

15. A method for modifying image data, the method comprising:
determining a first kernel for a pixel of an image based on pixel values of a window of pixels of the image;
determining a second kernel for the pixel of the image based on depth data of a window of depth information, wherein the depth information is related to the image;
combining the first kernel with the second kernel to generate a combined kernel; and
modifying the pixel based on the combined kernel.

16. The method of claim 15, further comprising determining a blur radius for the pixel, wherein:
a size of the first kernel is based on the blur radius;
a size of the window of pixels is based on the blur radius;
a size of the second kernel is based on the blur radius; and
a size of the window of depth information is based on the blur radius.

17. The method of claim 16, wherein the blur radius for the pixel is based on depth data related to the pixel.

18. The method of claim 16, wherein the blur radius for the pixel is determined based on a relationship between depth ranges and blur radii.

19. The method of claim 15, wherein determining the first kernel comprises comparing a respective pixel value of each pixel of the window of pixels to pixel values of pixels of the window of pixels to determine a respective weight of the first kernel.

20. The method of claim 15, wherein determining the second kernel comprises comparing a respective depth value of each depth of the window of depth information to depth values of depths of the window of depth information to determine a respective weight of the second kernel.
